(19) United States
(12) Patent Application Publication
(10) Pub. No.: US 2019/0071295 A1
(43) Pub. Date: Mar. 7, 2019

(54) BEVERAGE BOTTLE FILLING DEVICE OR CONTAINER FILLING DEVICE AND A METHOD FOR FILLING BEVERAGE BOTTLES OR SIMILAR CONTAINERS WITH A BEVERAGE OR SIMILAR PRODUCT

(71) Applicant: Ludwig CLÜSSERATH, Bad Kreuznach (DE)

(72) Inventor: Ludwig CLÜSSERATH, Bad Kreuznach (DE)

(21) Appl. No.: 16/182,723

(22) Filed: Nov. 7, 2018

Related U.S. Application Data
(63) Continuation-in-part of application No. PCT/EP2017/061016, filed on May 9, 2017.

(30) Foreign Application Priority Data
May 9, 2016 (DE) 102016108502.2

(51) Int. Cl. B67C 3/22; B67C 7/00; B65B 21/02; B67C 3/26; B67C 3/28; B67C 3/20

(52) U.S. Cl. CPC B67C 3/225; B67C 7/004; B67C 3/20; B67C 3/2634; B67C 3/282; B65B 21/02

(57) ABSTRACT

A beverage bottle filling device or container filling device and a method for filling beverage bottles or similar containers with a beverage or similar product. The abstract of the disclosure is submitted herewith as required by 37 C.F.R. § 1.72(b). As stated in 37 C.F.R. § 1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation-In-Part application of International Patent Application No. PCT/EP2017/061016, filed on May 9, 2017, which claims priority from Federal Republic of Germany Patent Application No. 10 2016 108 502.2, filed on May 9, 2016. International Patent Application No. PCT/EP2017/061016 was pending as of the filing date of this application. The United States was an elected state in International Patent Application No. PCT/EP2017/061016.

### BACKGROUND

### 1. Technical Field

The present application relates to a beverage bottle filling device or container filling device and a method for filling beverage bottles or similar containers with a beverage or similar product, such as beer, water, or soda pop.

### 2. Background Information

Background information is for informational purposes only and does not necessarily admit that subsequently mentioned information and publications are prior art.

In the field of bottle and container filling, a primary goal for cost-efficiency is to try to fill the bottles or other containers as quickly as possible in order for a bottling or container-filling facility to produce as many filled bottles or filled containers as possible. However, the types of beverage bottles and other containers are varied, as are the types of products that are filled into the beverage bottles and other containers, which variation affects the filling speed and filling process. In addition, different beverage bottles and other containers, as well as different products that are filled into the beverage bottles and other containers, usually require different types of filling structures and machinery to accomplish fast filling. Often such filling structures and machinery are large and complex in design. Large and complex machinery can be expensive to build and install, and also can be expensive to maintain. It therefore is usually desirable to try to minimize the size and complexity of such machinery in order to reduce costs of installation and maintenance. However, such a reduction in size and complexity should not also result in a reduction in productivity and efficiency.

Some types of beverages and liquid products require even more specialized handling equipment than do others. For example, sensitive beverages like beer, soda, various fizzy drinks, sparkling water, soda water, and other similar beverages or liquids generally utilize handling equipment that is specifically designed for these beverages and liquids since the handling of these beverages and liquids presents unique challenges. Such equipment can often be relatively large, complex, and expensive.

The present application discloses a beverage bottle filling device or container filling device and a method for filling beverage bottles or similar containers with a liquid beverage or similar liquid product, in which the size and complexity of the machinery is reduced, but a high rate of filling is maintained. The present application further relates to a method for filling containers, for example bottles, wherein carbonated beverages, such as soda, fizzy drinks, or similar liquids, are filled into the containers, which are under pressure.

Some beverage filling processes of this type involve a carbonated beverage being filled into an evacuated container, for example a bottle. With this method of filling the evacuated bottle, the filling operation is effected extremely rapidly, after which the pressure in the container cannot be relieved quickly without excessive effervescence, leading to problems when the bottle is transported under atmospheric pressure to the closing process. With this method, the filling operation is combined with the container closing operation directly at the filling point. The closing operation takes place in a gas chamber above the bottle at a pressure above the carbon dioxide saturation pressure. The pressure in the bottle is not reduced between the filling and closing processes. The disadvantage of this approach is that all or some or most filling points also have to be configured to close containers by way of complex technology.

### OBJECT OR OBJECTS

It is an object of the present application to provide a rapid filling method.

### SUMMARY

According to the present application, there is provided by a method according to at least one possible embodiment disclosed herein. Additional features or other exemplifications of the present application are disclosed herein. The specification and drawings also disclose possible embodiments and features thereof.

According to a method of the present application: a) the container is evacuated to a very low residual pressure, b) after being evacuated, the container is flushed with steam or a steam-containing flushing gas, c) prior to opening the filling valve, the flushing gas pressure in the bottle is increased, for example to a pressure below atmospheric pressure or even above it, d) the filling valve is opened and the bottle is filled, the bottle being sealed off from the surrounding atmosphere, e) a settling phase is carried out in which the pressure in the container reaches carbon dioxide saturation pressure or higher, and f) the pressure in the bottle is relieved and the bottle is transported to the closer at atmospheric pressure.

According to the present application, provision is also made for step a) to be dispensed with, if necessary and/or desired. In this case, step b) would comprise the container being flushed with steam and/or a steam/gas mixture at existing pressure, for example atmospheric pressure, as a result of which the air present in the container is removed from the container and replaced, for example, with steam.

In principle, the method of the present application makes use of the procedure whereby a carbonated beverage with a very low content of oxygen or other foreign gas, filled into a container under vacuum, in which the residual gas content in the container comprises chiefly carbon dioxide and possible residues of water vapor, can be filled at a high filling speed with no excessive foaming after the end of the filling operation, or further, with no excessive foaming, when it is depressurized.

In the first step a) the container, in one possible exemplification the bottle, may be evacuated to a vacuum pressure. Then, in step b), a flushing is effected, in one possible exemplification with superheated steam, into the vacuum so as to completely remove the residual air as much as possible. At the start of and/or during this flushing operation in one possible exemplification, a certain quantity of carbon dioxide can also be dispensed into the flow of steam or separately into the bottle at the end of the steam treatment. During and/or at the end of the filling operation, additional carbon dioxide under pressure can again be blown into the bottle to essentially ensure and/or promote that at the end of the filling operation, a pressure is present in the bottle at which saturation pressure is attained or exceeded in the settling phase e). As the result of a very pure carbon dioxide atmosphere in the container, that is generated in a previous evacuation and carbon dioxide flushing process, into which a beverage with minimal proportions of dissolved oxygen or other proportions of foreign gas is filled, foam may occur to a limited extent during filling despite the strong flow turbulence brought about by the rapid inflow. Therefore, in a pure carbon dioxide pressure atmosphere, for example, the carbonic acid can be dissolved again in the beverage at lightning speed.

Shortly before the filling valve is opened in step c), the steam pressure in the bottle is increased, for example to atmospheric pressure or a pressure above atmospheric. If the filling valve subsequently opens in step d) under these conditions, then the steam in the bottle condenses very rapidly as the cold product flows in. The liquid product, generally being cool or relatively cold, initially causes a condensation of the steam, creating a high vacuum in the bottle. The liquid will then flow or be sucked at high velocity into the bottle. A very rapid filling of the container is effected as a result. If filling takes place into such an atmosphere with high turbulence, there will initially be a rapid release of carbon dioxide and with it, a transition of carbon dioxide from liquid phase to gaseous phase. The pressure in the container increases again due to this effect and due to the residual gas atmosphere compressed by the inflowing product. If the pressure in this filling phase exceeds the carbon dioxide saturation pressure, then a re-carbonizing takes place with the previously released carbon dioxide and with the residual carbon dioxide which was left in the bottle after it was evacuated and which is now compressed by the inflowing product. In other words, as the rise in pressure increases, the carbon dioxide returns to saturation pressure or above, but the carbonic acid is dissolved in the beverage again in a flash. The generated foam formation is kept within limits as a result. A small amount of carbon dioxide can be dosed into the container before the filling operation to prevent, restrict, and/or minimize the bottle from imploding in connection with a pure vapor atmosphere. This dosage can also contribute to the carbon dioxide saturation pressure being achieved in the settling phase e). From our known filling methods with the use of steam it is known that an atmosphere which is practically free from residual air (oxygen) can be created in the bottle with the aid of the steam flushing method.

It should be noted that this filling process is especially fast for low-viscosity products such as liquid beverages. Beverages such as water have a low viscosity, as do beverages that are similar to water or have a high water content, such as soda water, sparkling water, soda pop, sports drinks, and other similar drinks. Such drinks, when dispensed, as discussed above, will spread very quickly, if not near instantaneously, thereby causing a very rapid condensation of the steam and formation of a vacuum. This quick formation of the vacuum will only further accelerate the filling speed. Therefore, filling containers with low-viscosity beverages and similar liquids in this manner is extremely fast.

After a short settling phase in step e) at a pressure that is set depending on beverage or product, in step f) the pressure in the container is reduced to atmospheric pressure and the container is conveyed onward for closing.

When steam is used as a flushing medium the pressure in the bottle is in one possible exemplification reduced to atmospheric pressure so that a closing of the bottle is possible in the usual way.

With this method too, the rate at which the product flows into the bottle can be regulated by a combination of flow meter and regulating valve.

In one possible exemplification, and especially if a volumetric measurement by way of a flow meter is too slow for the abrupt filling, the required and/or desired fill quantity of the product can be dispensed into a preliminary vessel and abruptly released into the bottle. This is possible if the flow meter is no longer able to achieve an adequate measuring accuracy because of the high filling rate.

Using steam as a flushing medium has the added effect that micro-organisms harmful to the beverage are destroyed.

The beverage or filled product is in one possible exemplification filled by way of a switchable filling valve through a sealed connection between a storage tank and the container to be filled. A pressure equal to or greater than the carbon dioxide saturation pressure is in one possible exemplification set in the storage tank, which in one possible exemplification forms the carbon dioxide supply.

The actual pressure in the bottle can in one possible exemplification be set and/or regulated to the required and/or desire pressure level by a pressure sensor which is positioned in the filling valve and which is connected to the container.

It is also conceivable for the pressure in the bottle to be increased by the addition of carbon dioxide after evacuation. Depending on the pressure which is set in the container following the end of filling, a re-carbonization of the product in the bottle is carried out. It is equally possible to replace the evacuation process for removing the residual air by a pure carbon dioxide flushing process.

The new method has the advantage that the filling process proceeds very rapidly because of the great difference in pressure between storage tank and bottle. This leads to short filling times and hence to filling machines which are significantly smaller in size.

If required and/or desired, the filling rate can also be regulated by a regulating valve arranged in the supply to the container as a function of the volumetric flow rate measured by the flow meter. Alternatively the flow rate can also be limited by throttle elements.

In the case of non-carbonated, still beverages, the pressure in the storage tank can also be the atmospheric pressure or a pressure above atmospheric pressure.

The present application is in one possible exemplification designed for an open jet filling method. Within the context of the present application, the term ‘open jet filling’ is used to mean a filling method in which the liquid filled product flows from the liquid valve to the container to be filled in a free filling jet or filled product stream, with the flow of the filled product not being influenced or altered by guide elements such as for example deflectors, swirl bodies or short or long filling tubes. Open jet filling can be effected pressurelessly as well as under pressure. In the case of pressureless open jet filling the container is at ambient pressure and does not normally lie with its container mouth or opening against the filling element but is at a distance away from the filling element or from a delivery opening which is provided. If the container does lie with its container opening against the filling element during pressureless open jet filling however, then a gas path establishes a connection between the interior of the container and the environment, whereby pressureless filling is made possible. In one possible exemplification, the gas present in the container and displaced by the beverage flowing into the container also escapes to the environment through this gas path.

If the open jet filling takes place at a pressure which is different from ambient pressure then the mouth of the container is pressed and sealed up against the filling element and the pressure in the interior of the container is set to this different pressure—which can be both above or below ambient pressure—by being applied with a pre-loading gas or by being applied with a negative pressure.

The present application can however also be realized with filling elements which comprise flow guiding elements, e.g. a filling tube, to deliver the filled product into the container. In this case, with bottom-up filling at a high filling rate, fewer micro-bubbles can be blown in, which would lead to a rapid and low-foam depressurizing.

Superheated steam or a mixture of superheated steam and carbon dioxide is in one possible exemplification used as a flushing gas. Using such a flushing gas accomplishes two purposes: micro-organisms in the container are destroyed during or before filling, and the superheated steam condenses suddenly during filling, virtually achieving a vacuum filling. The vacuum in the container generated by the condensation of the steam from a gaseous or vapor state to a liquid state leads to a very rapid filling operation. An appropriate choice of the carbon dioxide content in the flushing gas can also result in the pressure in the container during the settling phase reaching carbon dioxide saturation pressure or above. This essentially ensures and/or promotes that the dispensed filled product does not outgas after depressurization. For this purpose a partial carbon dioxide pressure can also be set in the container in one possible exemplification after step b) and before step d). This too essentially ensures and/or promotes that as the beverage settles, the pressure in the container rises above carbon dioxide saturation pressure so that the beverage does not degas in the settling phase.

In other words, in one possible exemplification an amount of carbon dioxide can be added to the flushing gas at the start of or during the flushing step b) to create, for example, a carbon dioxide and steam flushing gas. Alternatively, the carbon dioxide can be added to the steam in the container after the flushing step b) but before the filling step d). The amount or volume of carbon dioxide added is selected in order to produce a desired pressure in the container. To further explain, in addition to the steam, the carbon dioxide generates pressure within the container which contributes to or is part of the total pressure in the container, that is, the carbon dioxide generates a so-called “partial pressure.” The amount of carbon dioxide is selected in order to contribute a predetermined or desired amount of pressure. This amount of pressure is in addition to the pressure generated by the steam, and also contributes to the pressure in the container when the steam condenses due to the filling of the container with a liquid. Therefore, this partial pressure can be set, so to speak, by selecting or predetermining an amount of carbon dioxide to add to the flushing gas or the container at some point at or after the beginning of flushing step b), but before the filling step d).

After depressurization in step f), the bottle is in one possible exemplification fed to a closing process. The closing process can then be carried out separately from the filling process. In terms of apparatus technology this is much easier to realize, since between the filling operation and the closing process the pressure over the bottle does not have to be maintained to prevent, restrict, and/or minimize a degassing of the filled product. In other words, no special or additional equipment, which can be costly, complex, and large, would be needed to maintain the pressure in the bottle or container between filling and closing.

It should be understood that the various exemplifications disclosed herein can be used to fill most any type of container with a liquid. Containers include, but are not limited to, bottles, cans, or similar containers for holding a liquid product, which includes liquid beverages such as beer, soda, fruit drinks, water, fizzy drinks, effervescent drinks, and other such or similar liquid beverages. The containers can be made of different materials, such as plastic, glass, metal, or a combination of materials. While the terms “container” and “bottle” are used at different times in the present application, the exemplifications disclosed herein should not be considered to be limited to filling any type of specific bottle or container. The preliminary vessel disclosed herein is also referred to as a dosage space.

The above-discussed exemplifications of the present invention will be described further herein below. When the word “invention” or “exemplification of the invention” is used in this specification, the word “invention” or “exemplification of the invention” includes “inventions” or “exemplifications of the invention”, that is the plural of “invention” or “exemplification of the invention”. By stating “invention” or “exemplification of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

The present application is described below by way of example in association with the attached drawings.

FIG. 1 shows a side view of a first exemplification of a filling methods with steam input as flushing gas in the open jet filling method;

FIG. 2 shows a second exemplification of the filling method according to the present application in substantial accordance with FIG. 1 using a filling tube for the guided filling of the bottle; and

FIG. 3 shows an example of a beverage bottling plant.

### DESCRIPTION OF EXEMPLIFICATION OR EXEMPLIFICATIONS

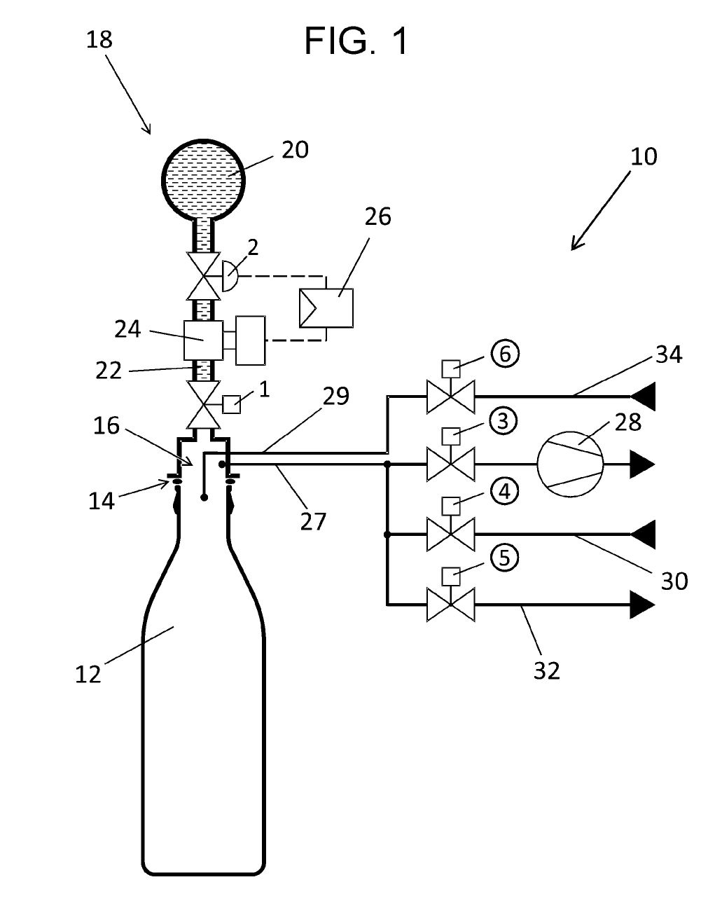

FIG. 1 shows a filling arrangement 10 for filling a container or bottle, wherein a bottle 12 lies against the delivery opening 16 of a filling element 18 by way of a seal 14. The filling element 18 is connected to a product supply 20, e.g. a storage tank. In the filling element 18 there is a vertical or substantially vertical product channel 22 in which are provided a product regulating valve 2, a volumetric flow meter 24, in one possible exemplification a magnetic-inductive flow meter (MID), a filling valve 1 and a regulator 26 which operates the product regulating valve 2 as a function of the value determined by way of the volumetric flow meter 24. The filling operation itself is controlled by the filling valve 1 which is arranged before the delivery opening 16. In the region above its delivery opening 16 the filling element 18 is connected to a supply tube 27 which can be connected to different sources. Thus the supply tube 27 can be connected by a first regulating valve 3 to a vacuum source 28, by a second regulating valve 4 to a carbon dioxide source 30 (e.g. the gas space of storage tank 20), by a third regulating valve 5 to a pressure-relief region 32, for example the environment In the exemplification shown, a separate supply tube 29 is connected by a fourth regulating valve 6 to a steam supply 34. However, in another possible exemplification, the separate supply tube 29 could be omitted and the steam source 34 could be connected to the supply tube 27, such that the steam source 34, the vacuum source 28, the carbon dioxide source 30, and the pressure-relief region 32.

According to at least one possible exemplification, the filling method first involves evacuating the bottle to a value of 0.05 to 0.15 bar, or possibly 0.05 to 0.20 bar, by opening the first regulating valve 3, while the second, third and fourth regulating valves 4, 5, 6 are closed. The first regulating valve 3 is then closed and the fourth regulating valve 6 is opened, thereby flushing the bottle 12 with steam.

Some carbon dioxide is possibly added at this point by the controlled opening of the second regulating valve 4 so as to subsequently essentially ensure and/or promote that the carbon dioxide pressure in the bottle in the settling phase rises above the saturation pressure of the carbon dioxide. The second regulating valve 5 and the fourth regulating valve 4 are then closed and the filling valve 1 is opened in order to supply the filled product to the bottle 12. At the end of the filling operation 1 the filling valve 1 is closed again with the quantity of the supplied filled product being determined by the volumetric flow meter 24. Alternatively, however, the product can also be supplied abruptly from a dosage space, in which case the volumetric measurement is effected during the supply of the filled product into the dosage space and not in the filling element 18. In this exemplification, there is one dosage space for each filling device, and each dosage space is filled with the desired amount of liquid to be dispensed into the particular size and type of container to be filled.

During the filling operation, carbon dioxide can be optionally applied to the bottle by the controlled opening of the second regulating valve 5. After closing the filling valve 1, the settling phase sets in during which the beverage settles and the pressure in the bottle 12 rises above the carbon dioxide saturation pressure. Finally, the third regulating valve 5 is opened so as to relieve the pressure in the bottle 12 which can now be transported onward to a closing process, for example to a closing machine.

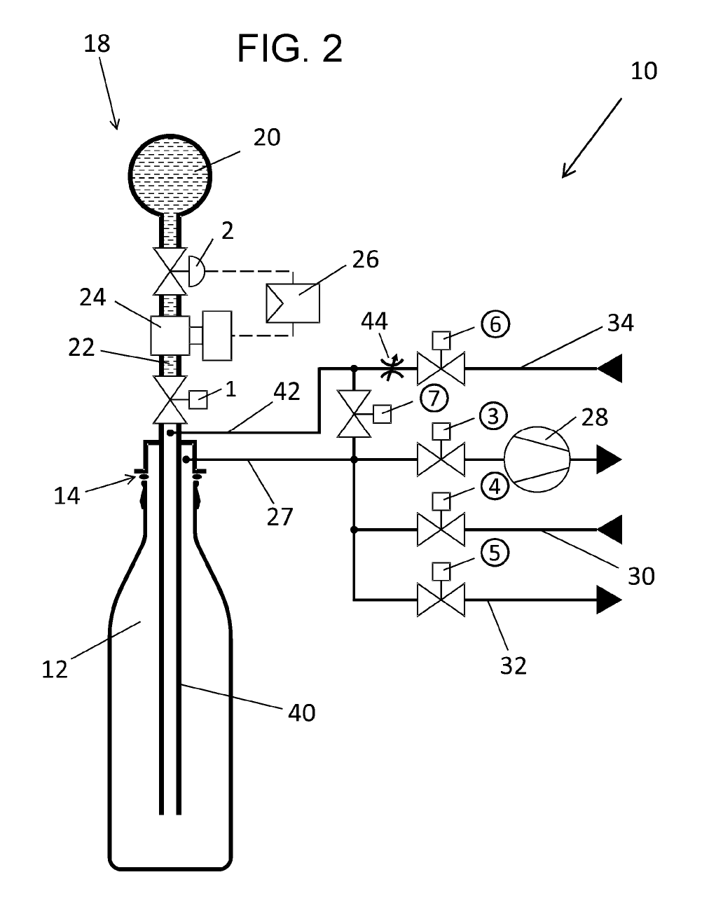

The exemplification in FIG. 2 differs from the previous exemplification in that in this case, the filling is not effected by the open jet filling method, but by way of a long filling tube 40 which is connected via the filling valve 1 to the product channel 22, as well as by a filling tube supply 42 which is connected via the fourth regulating valve 6 to the steam supply 34. The filling tube supply 42 also comprises an adjustable throttle 44 by way of which the flow of steam can be adjusted to a given value. Unlike the arrangement in FIG. 1, both the product and the steam are supplied through the filling tube 40. Between the supply tube 27 and the filling tube supply 42 there is arranged a fifth regulating valve 7 which on the one hand allows the steam to also be introduced into the container and/or into the bottle 12 through the supply tube 27, and which on the other hand allows the filling tube 40 to be connected to the vacuum source 28, the carbon dioxide source 30, or to the ambient air 32 by way of the corresponding regulating valves 3, 4 and 5.

The present application is not confined to the exemplifications described above but is capable of any variation within the protective scope of the present application.

The present application relates to a method for filling containers 12, in one possible exemplification bottles, in which a carbonated beverage is filled into a container under vacuum 12. The process comprises a sequence of the following steps: a) the vessel is evacuated to a residual pressure of 0.05 to 0.15 bar, b) the vessel is purged after evacuation with a vapor-containing purge gas, c) before opening the filling valve 1 increases the purge gas pressure in the bottle to atmospheric pressure or higher, d) the filling valve 1 is opened and the container is filled, the container being sealed from the ambient atmosphere 14, e) a settling phase is performed, f) the container is relieved.

Superheated steam or a mixture of superheated steam and carbon dioxide is in one possible exemplification used as a flushing gas. An appropriate choice of the carbon dioxide content in the flushing gas can also result in the pressure in the container during the settling phase reaching carbon dioxide saturation pressure or above. This essentially ensures and/or promotes that the dispensed filled product does not outgas after depressurization. For this purpose a partial carbon dioxide pressure of 0.02 to 0.2 bar, in one possible exemplification 0.05 to 0.15 bar, can also be set in the container in one possible exemplification at the beginning of or after step b) and before step d).

It should also be noted that the condensed steam, i.e., water, occupies a very small space in the container, so a substantial vacuum is created. For example, one cubic centimeter of water is equivalent to 1671 cubic centimeters of steam at 100° C. and one atmosphere. Thus, when the steam in the container condenses due to the introduction of the colder liquid during filling, very little residual water or condensation is left in the container.

It is an object of the present application to provide a rapid filling method which permits a separate closing operation with a prior depressurizing of the container.

It should be noted that a carbonated beverage or carbonated liquid, as discussed herein, refers to a CO₂-containing beverage or CO₂-containing liquid, that is, a beverage or liquid that contains carbon dioxide.

It should also be noted that exemplifications disclosed herein may also be utilized with nitrogen-infused beverages or similar liquids, or beverages that are infused with a combination of nitrogen and carbon dioxide. The flushing gas and other gases used in exemplifications of the method can also include nitrogen.

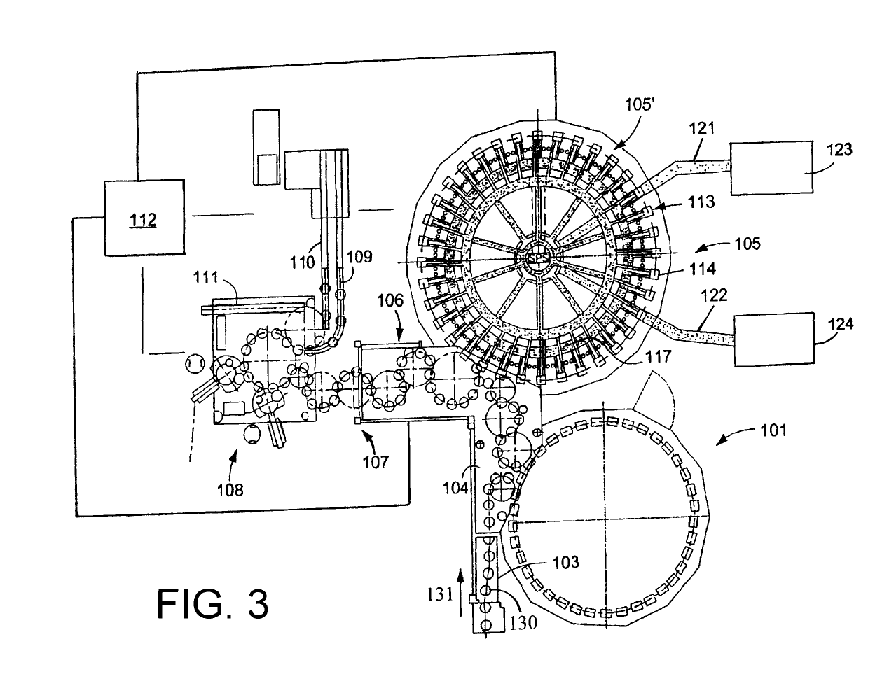

FIG. 3 shows schematically the main components of one possible exemplification of a system for filling containers, specifically, a beverage bottling plant for filling bottles 130 with at least one liquid beverage, in accordance with at least one possible exemplification, in which system or plant could possibly be utilized at least one aspect, or several aspects, of the exemplifications disclosed herein.

FIG. 3 shows a rinsing arrangement or rinsing station 101, to which the containers, namely bottles 130, are fed in the direction of travel as indicated by the arrow 131, by a first conveyer arrangement 103, which can be a linear conveyor or a combination of a linear conveyor and a starwheel. Downstream of the rinsing arrangement or rinsing station 101, in the direction of travel as indicated by the arrow 131, the rinsed bottles 130 are transported to a beverage filling machine 105 by a second conveyer arrangement 104 that is formed, for example, by one or more starwheels that introduce bottles 130 into the beverage filling machine 105.

The beverage filling machine 105 shown is of a revolving or rotary design, with a rotor 105′, which revolves around a central, vertical machine axis. The rotor 105′ is designed to receive and hold the bottles 130 for filling at a plurality of filling positions 113 located about the periphery of the rotor 105′. At each of the filling positions 103 is located a filling arrangement 114 having at least one filling device, element, apparatus, or valve. The filling arrangements 114 are designed to introduce a predetermined volume or amount of liquid beverage into the interior of the bottles 130 to a predetermined or desired level.

The filling arrangements 114 receive the liquid beverage material from a toroidal or annular vessel 117, in which a supply of liquid beverage material is stored under pressure by a gas. The toroidal vessel 117 is a component, for example, of the revolving rotor 105′. The toroidal vessel 117 can be connected by means of a rotary coupling or a coupling that permits rotation. The toroidal vessel 117 is also connected to at least one external reservoir or supply of liquid beverage material by a conduit or supply line. In the embodiment shown in FIG. 3, there are two external supply reservoirs 123 and 124, each of which is configured to store either the same liquid beverage product or different products. These reservoirs 123, 124 are connected to the toroidal or annular vessel 117 by corresponding supply lines, conduits, or arrangements 121 and 122. The external supply reservoirs 123, 124 could be in the form of simple storage tanks, or in the form of liquid beverage product mixers, in at least one possible embodiment.

As well as the more typical filling machines having one toroidal vessel, it is possible that in at least one possible embodiment there could be a second toroidal or annular vessel which contains a second product. In this case, each filling arrangement 114 could be connected by separate connections to each of the two toroidal vessels and have two individually-controllable fluid or control valves, so that in each bottle 130, the first product or the second product can be filled by means of an appropriate control of the filling product or fluid valves.

Downstream of the beverage filling machine 105, in the direction of travel of the bottles 130, there can be a beverage bottle closing arrangement or closing station 106 which closes or caps the bottles 130. The beverage bottle closing arrangement or closing station 106 can be connected by a third conveyer arrangement 107 to a beverage bottle labeling arrangement or labeling station 108. The third conveyor arrangement may be formed, for example, by a plurality of starwheels, or may also include a linear conveyor device.

In the illustrated embodiment, the beverage bottle labeling arrangement or labeling station 108 has at least one labeling unit, device, or module, for applying labels to bottles 130. In the embodiment shown, the labeling arrangement 108 is connected by a starwheel conveyer structure to three output conveyer arrangements: a first output conveyer arrangement 109, a second output conveyer arrangement 110, and a third output conveyer arrangement 111, all of which convey filled, closed, and labeled bottles 130 to different locations.

The first output conveyer arrangement 109, in the embodiment shown, is designed to convey bottles 130 that are filled with a first type of liquid beverage supplied by, for example, the supply reservoir 123. The second output conveyer arrangement 110, in the embodiment shown, is designed to convey bottles 130 that are filled with a second type of liquid beverage supplied by, for example, the supply reservoir 124. The third output conveyer arrangement 111, in the embodiment shown, is designed to convey incorrectly labeled bottles 130. To further explain, the labeling arrangement 108 can comprise at least one beverage bottle inspection or monitoring device that inspects or monitors the location of labels on the bottles 130 to determine if the labels have been correctly placed or aligned on the bottles 130. The third output conveyer arrangement 111 removes any bottles 130 which have been incorrectly labeled as determined by the inspecting device.

The beverage bottling plant can be controlled by a central control arrangement 112, which could be, for example, computerized control system that monitors and controls the operation of the various stations and mechanisms of the beverage bottling plant.

One feature or aspect of an exemplification is believed at the time of the filing of this patent application to possibly reside broadly in a method for filling containers 12, in one possible exemplification bottles, wherein a carbon dioxide-containing beverage is filled into a container 12 under pressure, comprising a sequence of the following steps: a) container is in one possible exemplification evacuated, for example to a residual pressure of 0.05 to 0.15 bar; b) the container is flushed with a steam and/or steam-containing flushing gas; c) the flushing gas pressure in the container is increased, in one possible exemplification to atmospheric pressure or higher, prior to the opening of a filling valve 1 for filling the container; d) the filling valve 1 is opened and the container 12 is filled, with the container being sealed from the surrounding atmosphere 14; e) a settling phase is carried out; and f) the pressure in the container is relieved.

Another feature or aspect of an exemplification is believed at the time of the filing of this patent application to possibly reside broadly in the method wherein the flushing gas is superheated steam or a mixture of superheated steam and carbon dioxide.

Yet another feature or aspect of an exemplification is believed at the time of the filing of this patent application to possibly reside broadly in the method wherein a partial carbon dioxide pressure of 0.02 to 0.2, in one possible exemplification 0.05 to 0.1 bar, is set in the container 12 after step b) and before step d).

Still another feature or aspect of an exemplification is believed at the time of the filing of this patent application to possibly reside broadly in the method wherein the partial carbon dioxide pressure is set to such a level that the pressure in the container 12 during the settling phase reaches carbon dioxide saturation pressure or above.

A further feature or aspect of an exemplification is believed at the time of the filing of this patent application to possibly reside broadly in the method wherein carbon dioxide is supplied to the container 12 before and/or during filling and/or after filling.

Another feature or aspect of an exemplification is believed at the time of the filing of this patent application to possibly reside broadly in the method wherein the container 12 is filled in the open jet filling method.

Yet another feature or aspect of an exemplification is believed at the time of the filing of this patent application to possibly reside broadly in the method wherein the dispensed quantity of filled product is measured volumetrically 24 or by mass measurement.

Still another feature or aspect of an exemplification is believed at the time of the filing of this patent application to possibly reside broadly in the method wherein a pre-proportioned quantity of filled product is supplied from a dosage space.

A further feature or aspect of an exemplification is believed at the time of the filing of this patent application to possibly reside broadly in the method wherein after depressurization the container 12 is fed to a closing process.

One feature or aspect of an exemplification is believed at the time of the filing of this patent application to possibly reside broadly in a method of filling beverage containers, such as beverage bottles, with a beverage, such as beer, water, and soda pop, said method comprising the steps of: moving a beverage container into a beverage filling machine, which beverage filling machine comprises a plurality of beverage filling devices disposed about the perimeter of a rotor configured to rotate about an axis of rotation; rotating said rotor and thereby moving said beverage container along a circular transport path; storing a beverage in a beverage storage device operatively connected to said beverage filling devices; bringing said beverage container into engagement with one of said beverage filling devices; filling said beverage container with said beverage while moving said beverage container with said rotor; upon completion of filling of said beverage container with said beverage, moving said beverage container out of said filling machine to a first container transport; moving said beverage container with said first container transport to a container closing machine, which container closing machine comprises a plurality of container closing devices disposed about the perimeter of a rotor configured to rotate about an axis of rotation; rotating said rotor of said container closing machine and thereby moving said beverage container along a circular transport path; storing a supply of container closures in a closure storage device operatively connected to said container closing devices; bringing said beverage container into engagement with one of said container closing devices; closing said beverage container with a container closure while moving said beverage container with said rotor of said container closing machine; upon completion of closing of said beverage container with a closure, moving said beverage container out of said closing machine to a second container transport; moving said beverage container with said second container transport to a container handling machine, such as a container packaging machine to package beverage containers into packs of multiple beverage containers; said step of filling beverage containers with said beverage further comprising: evacuating said beverage container and thereby reducing container pressure in said beverage container to substantially less than a beverage storage pressure in said storage device; flushing said beverage container with a flushing gas, which flushing gas comprises steam; increasing said container pressure to at or near said beverage storage pressure; and opening a filling valve and dispensing said beverage into said beverage container, and thereby condensing said steam in said beverage container, and thereby reducing said container pressure to substantially less than said beverage storage pressure to create a vacuum in said container to promote rapid filling.

Another feature or aspect of an exemplification is believed at the time of the filing of this patent application to possibly reside broadly in a method of filling beverage containers, such as beverage bottles, said method comprising the steps of: bringing a beverage container into sealed engagement with a filling device such that the interior of said beverage container is sealed from the surrounding environment; storing a beverage in a storage device operatively connected to said filling device; evacuating said beverage container and thereby reducing container pressure in said beverage container to substantially less than a beverage storage pressure in said storage device; flushing said beverage container with a flushing gas, which flushing gas comprises steam; increasing said container pressure to at or near said beverage storage pressure; opening a filling valve and dispensing said beverage into said beverage container, and thereby condensing said steam in said beverage container, and thereby reducing said container pressure to substantially less than said beverage storage pressure to create a vacuum in said container to promote rapid filling; and filling said container with said beverage.

Yet another feature or aspect of an exemplification is believed at the time of the filing of this patent application to possibly reside broadly in the method, wherein said beverage comprises a carbonated or effervescent beverage, and the method further comprises: after said step of filling said container, permitting said beverage to settle in a settling phase; and adjusting said container pressure to ambient atmospheric pressure to permit transport of said container to a container closing machine under ambient atmospheric pressure with minimized foaming of said beverage.

Still another feature or aspect of an exemplification is believed at the time of the filing of this patent application to possibly reside broadly in the method, wherein the method further comprises: selecting an amount of carbonating gas to add to said beverage container sufficient to generate a predetermined amount of pressure; and during or after said step of flushing said beverage container and before said step of opening said filling valve, adding said amount of carbonating gas into said beverage container and generating said predetermined amount of pressure, which forms part of said container pressure.

A further feature or aspect of an exemplification is believed at the time of the filing of this patent application to possibly reside broadly in the method, wherein, in said step of generating said predetermined amount of pressure, said predetermined amount of pressure generated by said added carbonating gas is substantially less than said beverage storage pressure.

Another feature or aspect of an exemplification is believed at the time of the filing of this patent application to possibly reside broadly in the method, wherein said pressure generated by said carbonating gas, after condensation of said steam, is sufficient to maintain said container pressure during said settling phase at carbonating gas saturation pressure or above.

Yet another feature or aspect of an exemplification is believed at the time of the filing of this patent application to possibly reside broadly in the method, wherein said pressure generated by said carbonating gas is in the range of approximately 0.02 bar to 0.2 bar.

Still another feature or aspect of an exemplification is believed at the time of the filing of this patent application to possibly reside broadly in the method, wherein said step of evacuating said beverage container comprises reducing container pressure upon evacuation of said beverage container to approximately 0.05 to 0.15 bar.

A further feature or aspect of an exemplification is believed at the time of the filing of this patent application to possibly reside broadly in the method, wherein said flushing gas is superheated steam or a mixture of superheated steam and carbonating gas.

Another feature or aspect of an exemplification is believed at the time of the filing of this patent application to possibly reside broadly in the method, wherein the method further comprises transporting said container to a container closing machine under ambient atmospheric pressure with minimized foaming of said beverage.

Yet another feature or aspect of an exemplification is believed at the time of the filing of this patent application to possibly reside broadly in the method, wherein said step of adding said amount of carbonating gas into said beverage container comprises adding all of said amount of carbonating gas in a single step or portions of said amount of carbonating gas over at least two steps, which step or steps are performed before said filling step and/or during said filling step and/or after said filling step.

Still another feature or aspect of an exemplification is believed at the time of the filing of this patent application to possibly reside broadly in the method, wherein said step of filling comprises open jet filling.

A further feature or aspect of an exemplification is believed at the time of the filing of this patent application to possibly reside broadly in the method, wherein said step of filling comprises measuring the amount of beverage to be dispensed volumetrically or by mass measurement.

Another feature or aspect of an exemplification is believed at the time of the filing of this patent application to possibly reside broadly in the method, wherein said step of filling comprises dispensing a pre-proportioned quantity of beverage from an individual dosage space.

Still another feature or aspect of an exemplification is believed at the time of the filing of this patent application to possibly reside broadly in the method, wherein said pressure generated by said carbonating gas is in the range of approximately 0.05 bar to 0.1 bar.

Yet another feature or aspect of an exemplification is believed at the time of the filing of this patent application to possibly reside broadly in the method, wherein said step of evacuating said beverage container comprises reducing container pressure upon evacuation of said beverage container to approximately 0.05 to 0.15 bar.

A further feature or aspect of an exemplification is believed at the time of the filing of this patent application to possibly reside broadly in the method, wherein said flushing gas is superheated steam or a mixture of superheated steam and carbonating gas.

Another feature or aspect of an exemplification is believed at the time of the filing of this patent application to possibly reside broadly in the method, wherein: the method further comprises transporting said container to a container closing machine under ambient atmospheric pressure with minimized foaming of said beverage; said step of adding said amount of carbonating gas into said beverage container comprises adding all of said amount of carbonating gas in a single step or portions of said amount of carbonating gas over at least two steps, which step or steps are performed before said filling step and/or during said filling step and/or after said filling step; said step of filling comprises open jet filling.

Yet another feature or aspect of an exemplification is believed at the time of the filing of this patent application to possibly reside broadly in the method, wherein: said step of filling comprises measuring the amount of beverage to be dispensed volumetrically or by mass measurement; or said step of filling comprises dispensing a pre-proportioned quantity of beverage from an individual dosage space.

One feature or aspect of an exemplification is believed at the time of the filing of this patent application to possibly reside broadly in a beverage container filling machine for performing the method of filling beverage containers, such as beverage bottles, said beverage container filling machine comprising: a filling device comprising a dispensing opening with a seal configured to engage and seal the interior of a beverage container from the surrounding environment; a beverage storage device operatively connected to said filling device; a vacuum source configured to evacuate a beverage container and thereby reducing container pressure in a beverage container to substantially less than a beverage storage pressure in said storage device; a flushing gas source configured to flush a beverage container with a flushing gas, which flushing gas comprises steam; a carbonating gas source configured to supply added carbonating gas to the interior of a beverage container; said filling device comprising a filling valve configured to be opened to dispense a beverage into a beverage container; a pressure release configured to release pressure from the interior of a beverage container; and at least one supply tube configured to operatively connect said vacuum source, said flushing gas source, said carbonating gas source, and said pressure release to the interior of a beverage container.

The components disclosed in the patents, patent applications, patent publications, and other documents disclosed or incorporated by reference herein, may possibly be used in possible exemplifications of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one exemplification of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various exemplifications may be used with at least one exemplification or all of the exemplifications, if more than one exemplification is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications, patent publications, and other documents cited herein, and in the Declaration attached hereto, are hereby incorporated by reference as if set forth in their entirety herein except for the exceptions indicated herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, patent applications, patent publications, and other documents which are included in this application and which are referred to in paragraphs which state “Some examples of . . . which may possibly be used in at least one possible exemplification of the present application . . . ” may possibly not be used or useable in any one or more exemplifications of the application.

The sentence immediately above relates to patents, patent applications, patent publications, and other documents either incorporated by reference or not incorporated by reference.

All of the patents, patent applications, patent publications, and other documents, except for the exceptions indicated herein, which were cited in the German Office Action dated Nov. 28, 2016, and/or cited elsewhere, as well as the German Office Action document itself, are hereby incorporated by reference as if set forth in their entirety herein except for the exceptions indicated herein, as follows: DE 10 2014 104 873 A1, having the English translation of the German title “DEVICE AND METHOD FOR FILLING A CONTAINER WITH A FILLING PRODUCT”, published on Oct. 8, 2015; and DE 14 92 421 A, having the German title “Verfahren and Vorrichtung zum Sterilisieren von Flaschen”, published on Jan. 29, 1970.

All of the patents, patent applications, patent publications, and other documents, except for the exceptions indicated herein, which were cited in the International Search Report dated Jul. 26, 2017, and/or cited elsewhere, as well as the International Search Report document itself, are hereby incorporated by reference as if set forth in their entirety herein except for the exceptions indicated herein, as follows: EP 0 705 788 A2, having the English translation of the German title “Method for filling bottles or similar containers with a liquid product”, published on Apr. 10, 1996; WO 2014/154332 A1, having the title “METHOD AND FILLING SYSTEM FOR FILLING CONTAINERS”, published on Oct. 2, 2014; and U.S. Pat. No. 3,570,556 A, having the title “METHOD OF AN APPARATUS FOR FILLING BOTTLES”, published on Mar. 16, 1971.

The corresponding foreign and international patent publication applications, namely, Federal Republic of Germany Patent Application No. 10 2016 108 502.2, filed on May 9, 2016, having inventor Ludwig CLÜSSERATH, and DE-OS 10 2016 108 502.2 and DE-PS 10 2016 108 502.2, and International Application No. PCT/EP2017/061016, filed on May 9, 2017, having WIPO Publication No. WO 2017/194515 A1 and inventor Ludwig CLÜSSERATH, are hereby incorporated by reference as if set forth in their entirety herein, except for the exceptions indicated herein, for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications, patent publications, and other documents, except for the exceptions indicated herein, are hereby incorporated by reference as if set forth in their entirety herein except for the exceptions indicated herein.

The purpose of incorporating the corresponding foreign equivalent patent application(s), that is, PCT/EP2017/061016 and German Patent Application 10 2016 108 502.2, is solely for the purposes of providing a basis of correction of any wording in the pages of the present application, which may have been mistranslated or misinterpreted by the translator, and to provide additional information relating to technical features of one or more exemplifications, which information may not be completely disclosed in the wording in the pages of this application.

Statements made in the original foreign patent applications PCT/EP2017/061016 and DE 10 2016 108 502.2 from which this patent application claims priority which do not have to do with the correction of the translation in this patent application are not to be included in this patent application in the incorporation by reference.

Any statements about admissions of prior art in the original foreign patent applications PCT/EP2017/061016 and DE 10 2016 108 502.2 are not to be included in this patent application in the incorporation by reference, since the laws relating to prior art in non-U.S. Patent Offices and courts may be substantially different from the Patent Laws of the United States.

All of the references and documents cited in any of the patents, patent applications, patent publications, and other documents cited herein, except for the exceptions indicated herein, are hereby incorporated by reference as if set forth in their entirety herein except for the exceptions indicated herein. All of the patents, patent applications, patent publications, and other documents cited herein, referred to in the immediately preceding sentence, include all of the patents, patent applications, patent publications, and other documents cited anywhere in the present application.

Words relating to the opinions and judgments of the author of all patents, patent applications, patent publications, and other documents cited herein and not directly relating to the technical details of the description of the exemplifications therein are not incorporated by reference.

The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned words in this sentence, when not used to describe technical features of one or more exemplifications of the patents, patent applications, patent publications, and other documents, are not considered to be incorporated by reference herein for any of the patents, patent applications, patent publications, and other documents cited herein.

The description of the exemplification or exemplifications is believed, at the time of the filing of this patent application, to adequately describe the exemplification or exemplifications of this patent application. However, portions of the description of the exemplification or exemplifications may not be completely applicable to the claims as originally filed in this patent application, as amended during prosecution of this patent application, and as ultimately allowed in any patent issuing from this patent application. Therefore, any statements made relating to the exemplification or exemplifications are not intended to limit the claims in any manner and should not be interpreted as limiting the claims in any manner.

The details in the patents, patent applications, patent publications, and other documents cited herein may be considered to be incorporable, at applicant's option, into the claims during prosecution as further limitations in the claims to patentably distinguish any amended claims from any applied prior art.

While various aspects and exemplifications have been disclosed herein, other aspects and exemplifications are contemplated. The various aspects and exemplifications disclosed herein are for purposes of illustration and not intended to be limiting. Additionally, the words “including,” “having,” and variants thereof (e.g., “includes” and “has”) as used herein, including the claims, shall be open-ended and have the same meaning as the word “comprising” and variants thereof (e.g., “comprise” and “comprises”).

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the exemplification or exemplifications, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. § 1.72(b). As stated in 37 C.F.R. § 1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The exemplifications of the invention described herein above in the context of the preferred exemplifications are not to be taken as limiting the exemplifications of the invention to all of the provided details thereof, since modifications and variations thereof may be made without departing from the spirit and scope of the exemplifications of the invention.

### LIST OF AT LEAST PARTIAL NOMENCLATURE

1 Filling valve
2 Product regulating valve
3 First regulating valve (vacuum)
4 Second regulating valve (carbon dioxide)
5 Third regulating valve (pressure relief)
6 Fourth regulating valve (steam)
7 Fifth regulating valve (filling tube supply/supply channel connection)
10 Filling arrangement
12 Bottle—container
14 Seal between filling element and bottle
16 Delivery opening
18 Filling element
20 Storage tank—Product tank
22 Product channel
24 Volumetric flow meter (MID)
26 Regulator
27 Supply tube
28 Vacuum source
29 Supply tube
30 Carbon dioxide source
32 Surrounding atmosphere
34 Steam source for superheated steam
40 Filling tube
42 Filling tube supply
44 Adjustable throttle

What is claimed is:

1. A method of filling beverage containers, such as beverage bottles, with a beverage, such as beer, water, and soda pop, said method comprising the steps of:
moving a beverage container into a beverage filling machine, which beverage filling machine comprises a plurality of beverage filling devices disposed about the perimeter of a rotor configured to rotate about an axis of rotation;
rotating said rotor and thereby moving said beverage container along a circular transport path;
storing a beverage in a beverage storage device operatively connected to said beverage filling devices;
bringing said beverage container into engagement with one of said beverage filling devices;
filling said beverage container with said beverage while moving said beverage container with said rotor;
upon completion of filling of said beverage container with said beverage, moving said beverage container out of said filling machine to a first container transport;
moving said beverage container with said first container transport to a container closing machine, which container closing machine comprises a plurality of container closing devices disposed about the perimeter of a rotor configured to rotate about an axis of rotation;
rotating said rotor of said container closing machine and thereby moving said beverage container along a circular transport path;
storing a supply of container closures in a closure storage device operatively connected to said container closing devices;
bringing said beverage container into engagement with one of said container closing devices;
closing said beverage container with a container closure while moving said beverage container with said rotor of said container closing machine;
upon completion of closing of said beverage container with a closure, moving said beverage container out of said closing machine to a second container transport;
moving said beverage container with said second container transport to a container handling machine, such as a container packaging machine to package beverage containers into packs of multiple beverage containers;
said step of filling beverage containers with said beverage further comprising:
evacuating said beverage container and thereby reducing container pressure in said beverage container to substantially less than a beverage storage pressure in said storage device;
flushing said beverage container with a flushing gas, which flushing gas comprises steam;
increasing said container pressure to at or near said beverage storage pressure; and
opening a filling valve and dispensing said beverage into said beverage container, and thereby condensing said steam in said beverage container, and thereby reducing said container pressure to substantially less than said beverage storage pressure to create a vacuum in said container to promote rapid filling.

2. A method of filling beverage containers, such as beverage bottles, said method comprising the steps of:
bringing a beverage container into sealed engagement with a filling device such that the interior of said beverage container is sealed from the surrounding environment;
storing a beverage in a storage device operatively connected to said filling device;
evacuating said beverage container and thereby reducing container pressure in said beverage container to substantially less than a beverage storage pressure in said storage device;
flushing said beverage container with a flushing gas, which flushing gas comprises steam;
increasing said container pressure to at or near said beverage storage pressure;
opening a filling valve and dispensing said beverage into said beverage container, and thereby condensing said steam in said beverage container, and thereby reducing said container pressure to substantially less than said beverage storage pressure to create a vacuum in said container to promote rapid filling; and
filling said container with said beverage.

3. The method according to claim 2, wherein said beverage comprises a carbonated or effervescent beverage, and the method further comprises:
after said step of filling said container, permitting said beverage to settle in a settling phase; and
adjusting said container pressure to ambient atmospheric pressure to permit transport of said container to a container closing machine under ambient atmospheric pressure with minimized foaming of said beverage.

4. The method according to claim 3, wherein the method further comprises:
selecting an amount of carbonating gas to add to said beverage container sufficient to generate a predetermined amount of pressure; and
during or after said step of flushing said beverage container and before said step of opening said filling valve, adding said amount of carbonating gas into said beverage container and generating said predetermined amount of pressure, which forms part of said container pressure.

5. The method according to claim 4, wherein, in said step of generating said predetermined amount of pressure, said predetermined amount of pressure generated by said added carbonating gas is substantially less than said beverage storage pressure.

6. The method according to claim 5, wherein said pressure generated by said carbonating gas, after condensation of said steam, is sufficient to maintain said container pressure during said settling phase at carbonating gas saturation pressure or above.

7. The method according to claim 6, wherein said pressure generated by said carbonating gas is in the range of approximately 0.02 bar to 0.2 bar.

8. The method according to claim 7, wherein said step of evacuating said beverage container comprises reducing container pressure upon evacuation of said beverage container to approximately 0.05 to 0.15 bar.

9. The method according to claim 8, wherein said flushing gas is superheated steam or a mixture of superheated steam and carbonating gas.

10. The method according to claim 9, wherein the method further comprises transporting said container to a container closing machine under ambient atmospheric pressure with minimized foaming of said beverage.

11. The method according to claim 10, wherein said step of adding said amount of carbonating gas into said beverage container comprises adding all of said amount of carbonating gas in a single step or portions of said amount of carbonating gas over at least two steps, which step or steps are performed before said filling step and/or during said filling step and/or after said filling step.

12. The method according to claim 11, wherein said step of filling comprises open jet filling.

13. The method according to claim 12, wherein said step of filling comprises measuring the amount of beverage to be dispensed volumetrically or by mass measurement.

14. The method according to claim 12, wherein said step of filling comprises dispensing a pre-proportioned quantity of beverage from an individual dosage space.

15. The method according to claim 6, wherein said pressure generated by said carbonating gas is in the range of approximately 0.05 bar to 0.1 bar.

16. The method according to claim 15, wherein said step of evacuating said beverage container comprises reducing container pressure upon evacuation of said beverage container to approximately 0.05 to 0.15 bar.

17. The method according to claim 16, wherein said flushing gas is superheated steam or a mixture of superheated steam and carbonating gas.

18. The method according to claim 17, wherein:
the method further comprises transporting said container to a container closing machine under ambient atmospheric pressure with minimized foaming of said beverage;
said step of adding said amount of carbonating gas into said beverage container comprises adding all of said amount of carbonating gas in a single step or portions of said amount of carbonating gas over at least two steps, which step or steps are performed before said filling step and/or during said filling step and/or after said filling step;
said step of filling comprises open jet filling.

19. The method according to claim 18, wherein:
said step of filling comprises measuring the amount of beverage to be dispensed volumetrically or by mass measurement; or
said step of filling comprises dispensing a pre-proportioned quantity of beverage from an individual dosage space.

20. A beverage container filling machine for performing the method according to claim 2 of filling beverage containers, such as beverage bottles, said beverage container filling machine comprising:
a filling device comprising a dispensing opening with a seal configured to engage and seal the interior of a beverage container from the surrounding environment;
a beverage storage device operatively connected to said filling device;
a vacuum source configured to evacuate a beverage container and thereby reducing container pressure in a beverage container to substantially less than a beverage storage pressure in said storage device;
a flushing gas source configured to flush a beverage container with a flushing gas, which flushing gas comprises steam;
a carbonating gas source configured to supply added carbonating gas to the interior of a beverage container;
said filling device comprising a filling valve configured to be opened to dispense a beverage into a beverage container;
a pressure release configured to release pressure from the interior of a beverage container; and
at least one supply tube configured to operatively connect said vacuum source, said flushing gas source, said carbonating gas source, and said pressure release to the interior of a beverage container.
